(19) United States
(12) Patent Application Publication
(10) Pub. No.: US 2002/0052797 A1
(43) Pub. Date: May 2, 2002

(54) Customizing a price of a product or a service by using an intelligent agent

(76) Inventors: L. Michael Maritzen, Fremont, CA (US); Harold Aaron Ludtke, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/930,608

(22) Filed: Aug. 15, 2001

Related U.S. Application Data
(60) Provisional application No. 60/254,412, filed on Dec. 8, 2000.
(60) Provisional application No. 60/227,856, filed on Aug. 23, 2000.

(51) Int. Cl. G06F 17/60

(52) U.S. Cl. 705/26

(57) ABSTRACT

An intelligent agent is configured to determine whether a product or a service satisfies preferences established by a party. The intelligent agent is also configured to use personal data associated with the party such as a historical purchase activity, a potential future purchase activity, or information related to a group to which the party is a member in order to customize a price for the product or the service. The intelligent agent, dispatched from a client to a server, customizes the price for the product or the service based upon the personal data associated with the party or a pricing policy of the supplier. The product or the service is purchased without disclosing the identity of the party.

### BACKGROUND OF THE INVENTION

This application claims the benefit of the earlier filing date of co-pending provisional application of L. Michael Maritzen and Harold Aaron Ludtke entitled, “Consumer-Centric Personalized Pricing and Discount Smart Agents for Acquisition of New Customers,” Serial No. 60/254,412, filed Dec. 8, 2000, which is herein incorporated by reference.

This application also claims the benefit of the earlier filing date of co-pending provisional application of Michael L. Maritzen, Tomitaka Tadafusa, and Aaron H. Ludtke entitled, “Consumer-Centric Personalized Pricing and Discount Smart Agents for Acquisition of New Customers,” Serial No. 60/227,856, filed Aug. 23, 2000 and incorporated herein by reference.

### FIELD OF THE INVENTION

The present invention relates generally to purchasing a product or a service from a supplier. More specifically, the invention relates to customizing a price for a product or a service and purchasing the product or service by using an intelligent agent.

### BACKGROUND

Computer systems that use intelligent agent software (also referred to as an intelligent agent or an agent) to find relevant information on a network such as the Internet are becoming increasingly popular. Intelligent agents operate like software-implemented “assistants” to automate, simplify, or perform certain tasks in a way that hides their complexity from the user. By using intelligent agents, a user may be able to obtain information without having to know how or where to search for the information.

Intelligent agents are characterized by the concept of delegation in which a user or a client entrusts the intelligent agents to handle tasks with a certain degree of autonomy. Intelligent agents operate with different constraints depending upon the amount of autonomy that is delegated to them by the user or the client.

Intelligent agents may also have differing capabilities in terms of intelligence, mobility, and user interface. Intelligence is generally the amount of reasoning and decision making that an agent possesses. This intelligence can be as simple as following a predefined set of rules, or as complex as learning and adapting to an environment based upon a user's objectives and the agent's available resources. An intelligent agent's intelligence or skill as applied to a specific field or function is referred to as domain knowledge.

Intelligent agents may also be mobile. Mobility is the ability to be passed through a network and execute on different computer systems. Accordingly, some intelligent agents may be designed to stay on one computer system and may never be passed to different machines, while other intelligent agents are designed to be passed from system to system while performing tasks at different stops along the way. In general, a user interface defines how an intelligent agent interacts with a user, if at all.

Intelligent agents have a number of uses in a wide variety of applications, including systems and network management, mobile access and management, information access and management, collaboration, messaging, workflow and administrative management, and adaptive user interfaces. Another important use for intelligent agents is in electronic commerce where an intelligent agent may be configured to seek out other parties such as suppliers, users, computer systems and intelligent agents, conduct negotiations on behalf of their client, and enter into commercial transactions.

Conventional intelligent agents used to perform electronic commercial transactions are limited. For example, if a user is interested in buying an inexpensive car (e.g., a Chevrolet Cavalier), an intelligent agent decodes the instructions, prepares a search command, and the search command is executed to locate suppliers of cars on a network. The intelligent agent then compares the prices listed at the sites, ranks the sites, and provides the list to the user. There are numerous disadvantages associated with this method of purchasing products over a network such as the Internet. First, conventional intelligent agents do not negotiate a purchase price for a product or a service. For instance, the best price available to the user may depend upon a variety of personal information related to the user (e.g., loyal Chevrolet customer, employee of General Motors Corporation, etc.), or other pertinent information. Second, conventional methods lack a secure industry-standard privacy model for exchanging consumer information and activities. For example, conventional methods typically reveal the identity of the potential consumer to the supplier. It is therefore desirable to have a method and a system that addresses the disadvantages associated with conventional methods and systems.

### SUMMARY

In one aspect, an intelligent agent is configured to determine whether a product or a service satisfies preferences established by a party. The intelligent agent is also configured to use personal information associated with the party such as a historical purchase activity of the party, a potential future purchase activity of the party, or information related to a group to which the party is a member to customize a price for the product or the service. The intelligent agent, dispatched from a client to a server, customizes the price for the product or the service based upon personal information related to the party, an arbitrary pricing policy, or other suitable information. The product or the service is purchased without disclosing the identity of the party.

### BRIEF DESCRIPTION OF THE DRAWINGS

The present invention is illustrated by way of example and not limited in the figures of the accompanying drawings, in which like references indicate similar elements and in which:

FIG. 1 is a block diagram of one embodiment for a system used to customize a price of a product or a service;

FIG. 2 is a block diagram of one embodiment of a secure transaction system;

FIG. 3 is a block diagram of one embodiment of a privacy card for a personal transaction device;

FIG. 4 is a block diagram of one embodiment of a digital wallet for a personal transaction device; and

FIG. 5 is a flow diagram of one embodiment for an intelligent agent used to customize a price and the purchase of a product or a service.

### DETAILED DESCRIPTION

In the following description, numerous specific details are set forth to provide a thorough understanding of the invention. However, it will be understood by one of ordinary skill in the art that the invention may be practiced without these specific details. In other instances, well known structures and techniques have not been shown in detail to avoid obscuring the invention.

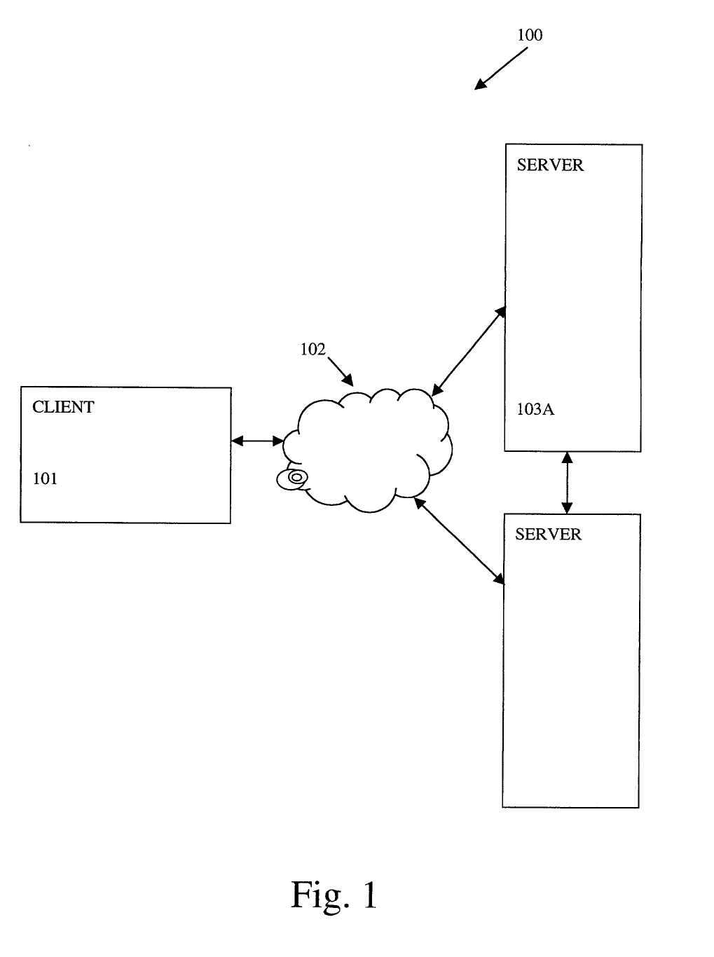

FIG. 1 is a block diagram for one embodiment of system 100 that is used by a mobile intelligent agent(s) configured to execute a transaction with a supplier at a web site operating on server 103A-103N. For clarity, definitions of transaction, product, and service are provided below; however, it will be appreciated that the claimed invention is not limited by these definitions. A transaction is a completion of an act(s) such as the purchase of a product or a service as in a business deal. A product is a good or other suitable item. The Uniform Commercial Code defines a good as “all things (including specially manufactured good) which are movable at the time of identification to the contract for sale other than the money in which the price is to be paid, investment securities and things in action. Goods also includes the unborn young of animals and growing crops and other identified things attached to realty as described in the section on goods to be several from realty (Section 2-107).” UCC §2-105. Service, on the other hand, is defined as a duty or as labor to be rendered by one person to another.

System 100 includes client 101 and conventional servers 103A-103N that are connected to network 102 such as the Internet or an intranet. In one embodiment, intelligent agent software, which operates on client 101 (or alternatively, server 103A-103N), customizes a secure link between client 101 and server 103A-103N according to preferences established by the user. In another embodiment, the intelligent agent prepares a request on behalf of the user (also referred to herein as a party or a consumer) of client 101, and the intelligent agent connects to network 102 to access servers 103A-103N in order to perform the task(s) that satisfy the requirements of the request. Tasks that the intelligent agent may be required to perform include registration of a user at a web site, matching preferences of a product or a server to products or services offered by suppliers, and negotiating a transaction. Each of these tasks is discussed below.

In one embodiment, an intelligent agent is configured to register a user at a web site provided that the user was not previously registered at the web site. Registration may involve providing information such as the user's e-mail address, choice of a password, zip code, or other applicable information. After properly registering the user at a web site, the intelligent agent is then ready to perform a search of the supplier's products or services to determine whether a match exists between that which is offered by the supplier and the user's preferences.

In one embodiment, the intelligent agent is instructed to exactly match the user's preferences for a product or a service with products or services that are offered by the supplier. For instance, assume that a user would like to obtain a copy of the book entitled “Catcher in the Rye” authored by J. D. Salinger. Here, there are three user preferences: (1) a book, (2) the title of the book, and (3) the author's name. In this example, the user would instruct the intelligent agent to obtain a perfect match of his or her preferences. The intelligent agent would then seek a supplier that met all three preferences.

In another embodiment, the user may instruct the intelligent agent that one or more preferences are not required to be exact matches. To illustrate, a user may instruct the intelligent agent that he would like a red Corvette model year 2002 for less than $40,000. Here, there are four preferences: (1) a Corvette, (2) model year 2002, (3) a price of less than $40,000, and (4) the color red for the exterior of the car. In this example, the color red is not a mandatory requirement but the cost is deemed a requirement that must be met. The intelligent agent matches the user preferences that are mandatory but not necessarily the requirements that the user has expressed flexibility such as the color of the Corvette.

An intelligent agent may be instructed to negotiate a transaction on behalf of either the user or the supplier, however, for the purpose of illustration, the following description involves an intelligent agent that negotiates on behalf of the user. Thereafter, two examples are presented. Example One involves an intelligent agent operating on behalf of the user and Example Two relates to an intelligent agent operating on behalf of the supplier.

In one embodiment, the intelligent agent is instructed by the user (or another intelligent agent operating on behalf of the user) to negotiate the best deal available to a user. The best deal may be the best price for a product or a service or it may be some other condition associated with the transaction that the user considers important (e.g., time of delivery of the product, etc.). In order to obtain the best deal available to the user, the intelligent agent is configured to use conventional means to provide the user's (or the party's) personal information to the supplier(s) or to provide information to the supplier that allows the user to benefit from pricing policies of the supplier. A party includes a person, a group of individuals, an organization or other suitable entity.

Personal information is defined as information that affects the party. Personal information includes, for example, financial information, past transactional information, elements of potential future transactions, or other suitable information. Specific categories of personal information include groups to which a party is a member, historical or potential future transactions involving purchasing or selling of products or services, or other suitable information.

A description of the categories of personal information and the policies of suppliers used to customize the price for a product or a service is described below.

Personal information such as a group to which the party is a member, historical or potential future transactions by or on behalf of the party, or other suitable information may be used to provide a discount in the price to the user or to provide something else that the user considers to have some value. Each of these components is described below.

A group is a number of persons that are gathered together to form a recognizable unit. A discount or some other valuable condition may be granted by a supplier to a user based upon a group in which the user is associated. There is a wide range of groups that are typically provided a discount. For example, discounts are regularly granted to members of groups such as the armed services, senior citizens, children, the American Medical Association (AMA), the American Bar Association (ABA), and other recognized groups.

In one embodiment, the intelligent agent may be configured to automatically provide this standard information to a supplier. Alternatively, this information is only provided to a supplier by an intelligent agent if the intelligent agent determines that a discount is available for one of the standard groups. The intelligent agent accomplishes this task by scanning the discounts that are indicated at the web site of the supplier.

Information pertaining to other arbitrarily established groups that are not typically recognized for a discount such as owners of German shepherds may still be provided to the intelligent agent (or, alternatively, the intelligent agent accesses the information) to pass to the supplier to obtain a discount from that supplier. In one embodiment, the intelligent agent may be configured to send a query, requesting this information, to the user for the next time the user accesses client 101. After receiving a response, the intelligent agent provides this information to the supplier.

Historical or potential future transactions may be such that the user qualifies for a discount or the user may be provided with something else that is of value to the user.

Historical transactions are transactions that the party has entered into in the past to purchase a product or a service. In one embodiment, the intelligent agent is configured to access data associated with past transaction data (e.g. credit card transactions), provide the data in a usable fashion to the supplier, and analyze data related to the user's transaction history in order to obtain the lowest price of the product or the service or to achieve some other relevant goal of the user (e.g., obtain a product faster than another customer who is not as important to the supplier as the user). One purpose of analyzing a transaction history may be to determine whether the user qualifies for a price of a product or service designed by the supplier to convert the user from purchasing a product that is, for example, brand X (e.g., Coke®) to brand Y (e.g., Pepsi®).

Another purpose of analyzing a transaction or transaction history of a user is to determine whether a user qualifies for additional discounts to purchase a product or a service from a supplier. A supplier may provide a discount for its products or services based upon factors related to a user's transaction history or potential future transaction. For example, if the user, located in Los Angeles, Calif., historically has purchased a large quantity of expensive wine, the supplier may grant the user a discount for the volume of wine that was previously purchased or the amount that is desired in the immediate transaction. An additional discount may also be provided due to the cost of the wine. A discount also may be provided to the user based upon the user being located in Los Angeles and the supplier being located in Northern California.

The amount of discount granted may be dependent upon the amount of information that the user is willing to share. If the user is willing to provide full access to his purchasing history, the user is more likely to receive the greatest amount of discount for the product or the service that the user desires. Conversely, users that are unwilling to provide complete access to their transaction history are more likely to receive less than a full discount. Accordingly, the discount received by a user may be dependent upon the user's level of comfort with sharing information that may be confidential. The manner and the type of information shared is described below.

An intelligent agent shares information with a supplier in a variety of ways. Information may be intelligently selected and provided to the supplier by using an intelligent agent, the user may select a level of privacy that is automatically implemented by the intelligent agent, or data mining may be performed by the supplier. Each of these processes is briefly described.

The process of intelligently selecting data is known in the art. Intelligently selected means that the intelligent agent reviews the potential discounts available at a supplier's web site and the intelligent agent selects only that data related to the user to which a discount may be provided. For example, the intelligent agent may select data that indicates that the user frequently purchases wine. The means by which information is accessed from client 101 or some other memory or database and shared by the intelligent agent is generally known in the art and is not further described in order to avoid obscuring techniques of the invention.

For purposes of illustrating a privacy level automatically implemented in system 100, three privacy levels are presented to show the type of information that may be shared. One skilled in the art will appreciate, however, that a variety of privacy levels with arbitrary factors established by the user, client 101, or the intelligent agent may be used to implement techniques of the invention. In the first level of privacy, for example, the user may share all historical transaction information such as all purchases made on his various credit cards (e.g., VISA, American Express, etc.) and banking information in which products were bought over a certain period of time such as five years. A second level of privacy may be that the user may wish to provide transaction information from a single transaction device (e.g., VISA) that does not include information showing that the user bought the same product using his bank account. Alternatively, only pertinent financial information is provided to the supplier such as the user's financial information, the volume of the product purchased, and one group that the user is a member. A third level of privacy may be that the user supplies his name and the location of where the product is to be delivered. Given the types of discounts described herein, one skilled in the art will appreciate that the level of privacy selected could affect the amount of discount granted.

In another embodiment, data mining may be performed on a user's transaction history, for instance, by the supplier in order to acquire new customers. Data mining is the analysis of data in a database using tools that look for trends or anomalies without knowledge of the meaning of the data. In this embodiment, the intelligent agent may be configured to perform data mining on the user's past purchases in order to determine, for example, the user's preferences for a product or service, the brand of product, the price paid for the product, or the service or other suitable information. This allows a supplier to make an offer to the user that the supplier believes the user would find attractive.

A supplier may provide a discount or something else of value to a user if the supplier is aware of an element(s) associated with a future transaction that is desirable to the supplier in some way. An element is a component, feature, or basic part of the transaction. To illustrate, an element of a future transaction may be the quantity of product to be purchased, the amount of services used, the cost associated with the product or service, the place or time the product is to be received by the user or other suitable features. This information may be shared, as previously described, with a supplier to obtain a discount.

In addition to personal information, pricing policies of the supplier may also affect the price of the product or the service. There are numerous pricing policies that may be created based upon standard or arbitrary features of the transaction. Examples of pricing policies that may be used by suppliers to provide discounts include the form of payment (e.g., credit card, check, money order, cash upon delivery, etc.), or the user is a customer of a third party supplier (e.g., a rental car company) that has a contract with the supplier (e.g., an airline) to provide a service at a discounted rate. A discount also may be granted to a user based upon a supplier's desire to expand into a certain geographic area or to distribute its product to a class of people such as an ethnic group. Additionally, discounts may also be provided to reward customer loyalty or, alternatively, to attract new customers. Products or services of the supplier may also be discounted if the product or service is not selling very well or there is a large quantity of the product in inventory.

To illustrate some of the techniques of the invention described herein, two examples are presented.

### EXAMPLE ONE

Assume that a user desires to purchase an inexpensive automobile such as a blue Chevrolet Cavalier, model year 2000, with a manual transmission. Assume also that the user would like to purchase the automobile at a finance rate less than 8 percent annual interest one month from the time in which the user provides his preferences to the intelligent agent software that operates from client 101. The user may also instruct the intelligent agent to perform its search at a time when client 101 is not needed by the user such as at 2:00 A.M. to allow for the maximum usage of client 101. At 2:00 A.M., the intelligent agent causes client 101 to connect to network 102 and to a server such as servers 103A-103N. The intelligent agent sends a request to, for example, server 103A that is based upon the preferences inputted into client 101 by the user.

Server 103A decodes the instructions for the request and returns two hypertext links that are Internet dealerships—Dealership A and Dealership B—that have a blue Chevrolet Cavalier, model year 2000 with a stick shift, that is offered for sale. The intelligent agent customizes the price for the car by applying pricing policies established by the supplier or by using personal information known by the intelligent agent about the user. Dealership A offers a 5 percent discount in the price if the user is an employee of General Motors Corporation and Dealership B offers a 2 percent discount provided that the automobile is purchased within twenty-four hours that its web site has been contacted.

In one embodiment, the intelligent agent may be instructed to automatically purchase the lowest priced automobile without interfacing with the user provided that the automobile is the same type of automobile offered by the different suppliers and the automobile meets all of the preferences of the user. In this example, since the intelligent agent does not know that the user is an employee of General Motors, the intelligent agent would purchase the automobile from Dealership B to obtain the additional 2 percent price reduction.

In another embodiment, the intelligent agent may be instructed to query the user if a pricing policy of a dealership offers a discount based upon information that is not known by the intelligent agent. For example, in the scenario presented above, Dealership A offers a discount if the user is an employee of General Motors Corporation. The user, who is in fact an employee of General Motors Corporation, receives a request from the intelligent agent for this information when the user accesses client 101. The user responds to the request and the next morning at 2:00 A.M. or some other designated time, the intelligent agent again connects to network 102 and provides this information to Dealership A. The intelligent agent determines the lowest price at each dealership by intelligently negotiating with each dealership, comparing the prices, and executing the transaction with the dealership that offers the lowest price.

In an alternate embodiment, the user may provide information to the intelligent agent indicating that another condition of the transaction is more important than the price of the product such as the time or the place of the delivery of the product. For example, suppose the user would like to accept delivery of the automobile in Los Angeles, Calif. on the Monday after the transaction has been completed. Assume further that Dealership A satisfies these requirements and Dealership B cannot deliver the automobile on Monday. In this situation, the intelligent agent would execute the transaction with Dealership A even though Dealership B offers the same automobile at a lower price. To implement this aspect of the invention, the intelligent agent may process an algorithm that incorporates various conditions that are assigned a certain weight by the user or the intelligent agent. In this manner, the intelligent agent will negotiate the final deal in a human-like manner and will select the proper supplier. The types of algorithms that may be used for this operation are varied but one example may be as follows:

In another embodiment, the intelligent agent may be configured to automatically forgo customizing a price for a product if a supplier has policies that are unacceptable to the user. For example, the user may find policies unacceptable that provide no warranties on the product. In this situation, after the intelligent agent determines that the supplier does not provide a warranty, the intelligent agent stops performing any additional activities with that supplier and moves on to the next supplier.

### EXAMPLE TWO

This example pertains to a supplier converting a user from purchasing products from another supplier. The user indicates through client 101 that he has a preference for Shiraz wine from Australia. All other types of wine are purchased from Trader Joe's Co. He also indicates through client 101 that with regard to transaction history, the supplier may be provided with historical transactions that occurred on a variety of his financial accounts (i.e., personal money, on-line banking statements, on-line credit card statements, etc.). The user further specifies that four bottles of wine with a total purchase price not to exceed $50 during a thirty day period may be automatically purchased. The user instructs the intelligent agent to perform daily searches at 4:00 A.M. while the user is not using client 101. Six weeks later, the intelligent agent determines that BEVMO.COM offers Shiraz wine at a 30% discount compared to the price offered at Trader Joe's. The intelligent agent then purchases the wine and has it delivered to the user's home. Since the user was not a customer at BEVMO.COM, the intelligent agent registers the user at BEVMO.COM. In this example, the user has been converted from a Trader Joe's customer to a BEVMO customer.

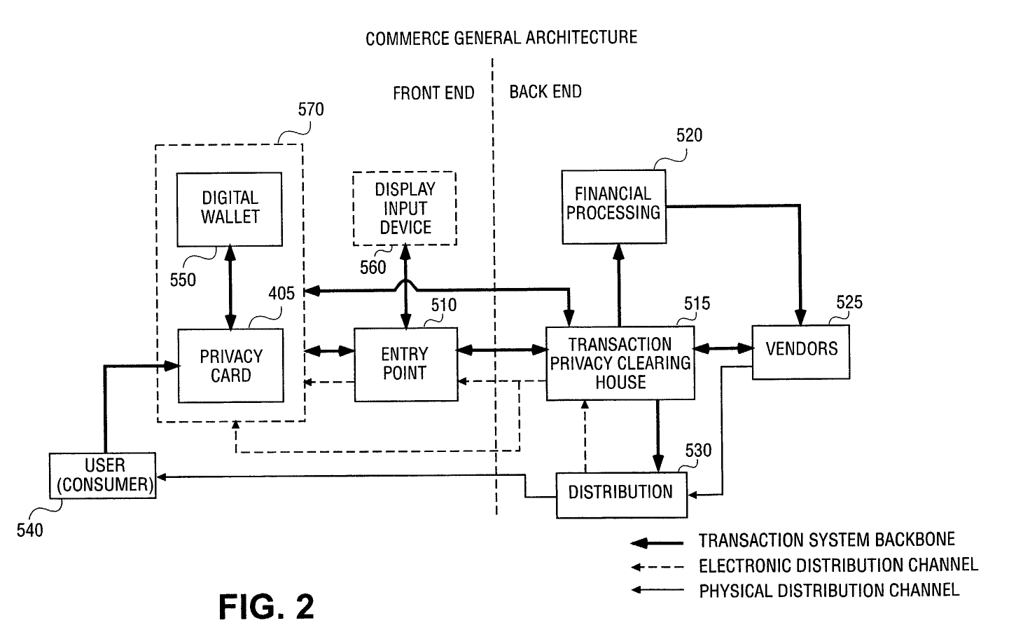

Given the description of how an intelligent agent may be designed to negotiate a transaction, another embodiment involves a secure transaction system that prevents the disclosure of a user's identity to suppliers. FIG. 2 is a block diagram of one embodiment of a secure transaction system, which may be used in electronic commerce. In this embodiment, transaction privacy clearing house (TPCH) 515 may be used to interface with the user (or consumer) 540 with vendor (supplier) 525. In this particular embodiment, a personal transaction device (PTD) 570, e.g., privacy card 405, or privacy card 405 coupled to digital wallet 550, is used to maintain the privacy of the user while enabling the user to perform transactions. In an alternate embodiment, PTD 570 may be any suitable device that allows unrestricted access to TPCH 515. For example, PTD 570 may include instruction logic implemented in a card (smart card) hand-held device or computer system of the user. The personal transaction device information is provided to TPCH 515 that then indicates to the vendor 525 and user 540 approval of the transaction to be performed.

In order to maintain confidentiality of the identity of user 540, the transaction device information does not provide user identification information. Thus, vendor 525 or other entities do not have user information. Instead, vendor 525 receives transaction device information. TPCH 515 maintains a secure database of transaction device information and user information. In one embodiment, financial information such as a credit card account and billing name and address is provided by user 540 to PTD 570. PTD 570 provides the financial information, exclusive of the user name and/or billing address to TPCH 515. TPCH 515 interfaces to at least one financial processing system 520 to perform associated financial transactions, such as confirming sufficient funds to perform the transaction, and transfers to vendor 525 the fees required to complete the transaction. In addition, TPCH 515 may also provide information through distribution function 530 that, in one embodiment, may provide a purchased product to user 540, again without vendor 525 knowing the identification of user 540. In an alternate embodiment, the financial processing system 520 need not be a separate entity but may be incorporated with other functionality. For example, in one embodiment, the financial processing system 520 may be combined with TPCH 515 functionality.

In one embodiment, financial processing system 520 performs tasks of transferring funds between the user's account and the vendor's account for each transaction. In one embodiment, the presence of TPCH 515 means that no details of the transactions, other than the amount of the transactions and other basic information (such as an account number), are known to financial processing system 520. TPCH 515 issues transaction authorizations to financial processing system 520 function on an anonymous basis on behalf of the user over a highly secure channel. Financial processing system 520 does not need to have many electronic channels receiving requests for fund transfer, as in a traditional financial processing system. In one embodiment, a highly secure channel is set up between TPCH 515 and financial processing system 520; thus, financial processing system 520 is less vulnerable to spoofing.

In one embodiment, financial processing system 520 is contacted by TPCH 515 requesting a generic credit approval of a particular account. Thus, financial processing system 520 receives a minimal amount of information. In one embodiment, the transaction information, including the identification of goods being purchased with the credit need not be passed to financial processing system 520. TPCH 515 may request the credit using a dummy charge ID that can be listed in the monthly credit statement sent to the user, so that the user can reconcile his credit statement. Further, PTD 570 may include functionality to cause the credit statement to convert the dummy charge ID back to the transactional information so that the credit statement appears to be a conventional statement that lists the goods that were purchased and the associated amount charged.

Display input device 560 (shown in phantom) may be included to enable the user, or in some embodiments vendor 525, to display status and provide input regarding PTD 570 and the status of the transaction to be performed.

In yet another embodiment, entry point 510 interfaces with PTD 570 and also communicates with TPCH 515. Entry point 510 may be an existing (referred to herein as a legacy point of sale (POS) terminal) or a newly configured POS terminal located in a retail environment. User 540 uses PTD 570 to interface to the POS terminal in a manner similar to how credit cards and debit cards interface with POS terminals. Entry point 510 may also be a public kiosk, a personal computer, or the like.

The system described herein may also provide distribution function 530 whereby products purchased via the system are distributed. In one embodiment, distribution function 530 is integrated with TPCH 515 functionality. In an alternate embodiment, distribution function 530 may be separate from TPCH 515. Utilizing either approach, the system ensures user privacy and data security. Distribution function 530 interacts with the user through PTD 570 to ship the product to the appropriate location. A variety of distribution systems are contemplated, for example, electronic distribution through a POS terminal coupled to the network, electronic distribution direct to one or more privacy cards and/or digital wallets, or physical product distribution. In one embodiment for physical product distribution, an “anonymous drop-off point”, such as a convenience store or other ubiquitous location is used. In another embodiment, a “package distribution kiosk” is used that allows the user to retrieve the package from the kiosk in a secure fashion. However, in one embodiment, the user may use PTD 570 to change the shipping address of the product at any time during the distribution cycle.

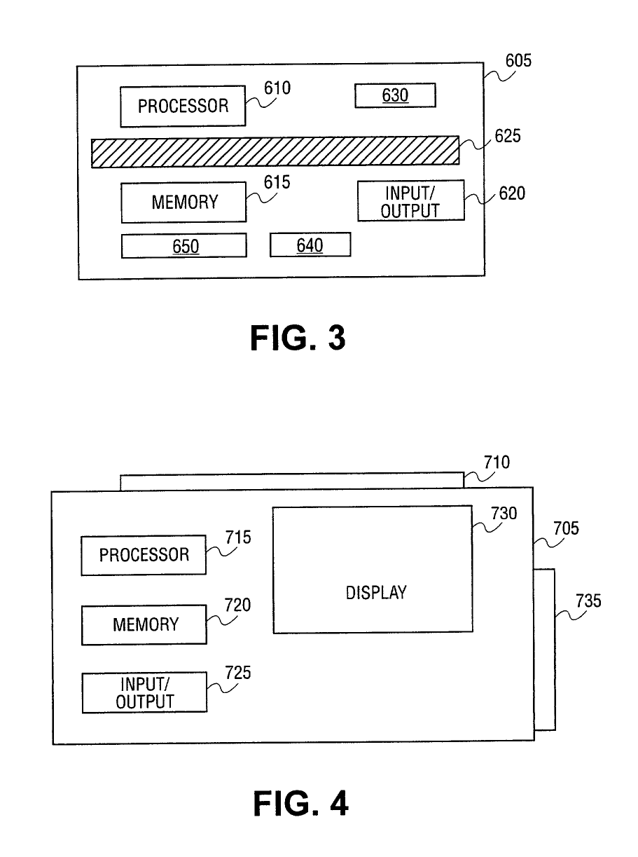

One embodiment of privacy card 605 is illustrated in FIG. 3. In one embodiment, privacy card 605 is configured to be the size of a credit card. Privacy card 605 includes processor 610, memory 615 and input/output logic 620. Processor 610 is configured to execute instructions to perform the functionality herein. The instructions may be stored in memory 615. Memory 615 is also configured to store data, such as transaction data and the like. In one embodiment, memory 615 stores the transaction ID used to perform transactions in accordance with the teachings of the present invention. Alternately, the processor may be replaced with specially configured logic to perform the functions described here.

Input/output logic 620 is configured to enable privacy card 605 to send and receive information. In one embodiment, input/output logic 620 is configured to communicate through a wired or contact connection. In another embodiment, input/output logic 620 is configured to communicate through a wireless or contactless connection. A variety of communication technologies may be used.

In one embodiment, display 625 is used to generate bar codes scanable by coupled devices and used to perform processes as described herein. Privacy card 605 may also include magnetic stripe generator 640 to simulate a magnetic stripe readable by devices such as legacy POS terminals.

In one embodiment, biometric information, such as fingerprint recognition, is used as a security mechanism that limits access to privacy card 605 to authorized users. A fingerprint touch pad and associated logic 630 is therefore included in one embodiment to perform these functions. Alternately, security may be achieved using a smart card chip interface 650, which uses known smart card technology to perform the function.

Memory 615 can have transaction history storage area. The transaction history storage area stores transaction records (electronic receipts) that are received from POS terminals. The ways for the data to be input to the card include wireless communications and the smart card chip interface which functions similar to existing smart card interfaces. Both of these approaches presume that the POS terminal is equipped with the corresponding interface and can therefore transmit the data to the card.

Memory 615 can also have user identity/account information block. The user identity/account information block stores data about the user and accounts that are accessed by the card. The type of data stored includes the meta account information used to identify the account to be used.

One embodiment of a digital wallet 705 is illustrated in FIG. 4. Digital wallet 705 includes coupling peripheral port 710 for privacy care 605, processor 715, memory 720, input/output logic 725, display 730 and peripheral port 735. The processor 715 is configured to execute instructions, such as those stored in memory 720, to perform the functionality described herein. Memory 720 may also store data including financial information, eCoupons, shopping lists and the like. The digital wallet may be configured to have additional storage. In one embodiment, the additional storage is in a form of a card that couples to the device through peripheral port 710.

In one embodiment, privacy card 605 couples to digital wallet 705 through peripheral port 710; however, privacy card 605 may also couple to digital wallet 705 through another form of connection including a wireless connection.

Input/output logic 725 provides the mechanism for the digital wallet 705 to communicate information. In one embodiment, the input/output logic 725 provides data to a POS terminal or to privacy card 605 in a pre-specified format. The data may be output through a wired or wireless connection.

Digital wallet 705 may also include display 730 for display of status information to the user. Display 730 may also provide requests for input and may be a touch sensitive display, enabling the user to provide the input through the display.

The physical manifestation of many of the technologies in digital wallet 705 will likely be different from those in privacy card 605, mainly because of the availability of physical real estate in which to package technology. Examples of different physical representations would include the display, fingerprint recognition unit, etc.

The components of a secure transaction system illustrated in FIGS. 2, 3, and 4 are further described in PCT published patent application number US00/35619, which is assigned to the same assignee as the present application and that is hereby incorporated by reference.

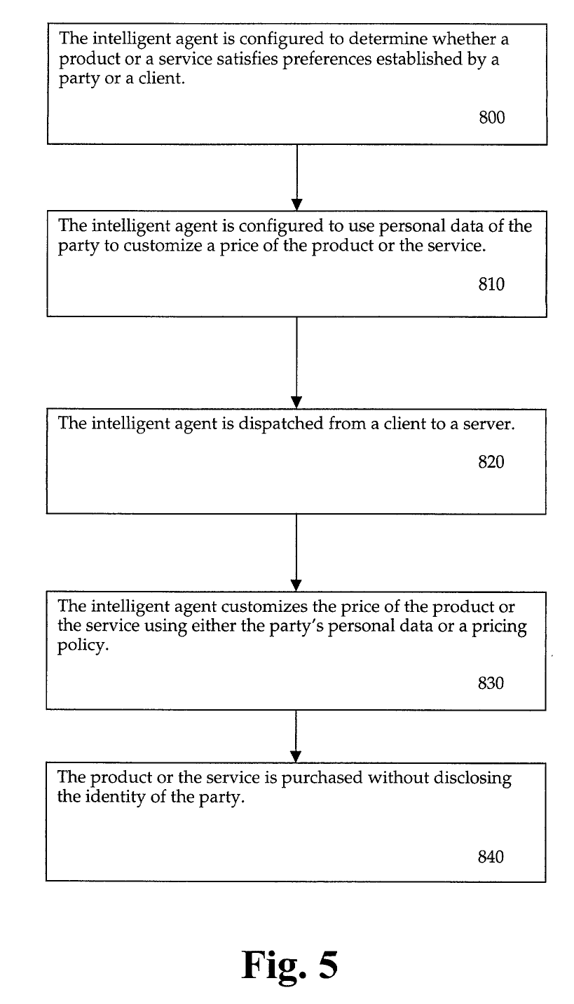

FIG. 5 is a flow diagram of one embodiment of an intelligent agent used to customize a price of a product or a service. At block 800, the intelligent agent is configured to determine whether a product or a service satisfies preferences established by a party or a client. At block 810, the intelligent agent is configured to use personal data of the party to customize a price of the product or the service. At block 820, the intelligent agent is dispatched from a client to a server. At block 830, the intelligent agent customizes the price of the product or the service using either the party's personal data or a pricing policy. At block 840, the product or the service is purchased using the secure transaction system described with reference to FIGS. 2-4 without disclosing the identity of the party.

It will be appreciated that that more or fewer processes may be incorporated into the method illustrated in FIG. 5 without departing from the scope of the invention and that no particular order is implied by the arrangement of blocks shown and described herein. It further will be appreciated that the method described in conjunction with FIG. 5 may be embodied in machine-executable instructions, e.g., software. The instructions can be used to cause a general-purpose or special-purpose processor that is programmed with the instructions to perform the operations described. Alternatively, the operations might be performed by specific hardware components that contain hardwired logic for performing the operations, or by any combination of programmed computer components and custom hardware components. The methods may be provided as a computer program product that may include a machine-readable medium having stored thereon instructions which may be used to program a computer (or other electronic devices) to perform the methods. For the purposes of this specification, the terms “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to included, but not be limited to, solid-state memories, optical and magnetic disks, and carrier wave signals. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or a produce a result.

In the preceding detailed description, the invention is described with reference to specific embodiments thereof. It will, however, be evident that various modifications and changes may be made thereto without departing from the broader spirit and scope of the invention as set forth in the claims. One skilled in the art will appreciate that although techniques of the invention are described relative to a client-server architecture, other suitable architectures may be used such as peer-to-peer architectures. The specification and drawings are, accordingly, to be regarded in an illustrative rather than a restrictive sense.

What is claimed is:

1. A computer-implemented method in which at least one intelligent agent negotiates the purchase of a product or a service on behalf of a party, the computer-implemented method comprising:
configuring the at least one intelligent agent to:
(a) determine whether one of the product and the service offered by a supplier satisfies preferences established by the party;
(b) use personal data associated with the party to customize a price for one of the product and the service, the personal data selected from the group consisting of a historical purchase activity of the party, a potential future purchase activity of the party, and a group to which the party is a member;
dispatching the at least one intelligent agent from a client to a server;
using the at least one intelligent agent to customize the price for one of the product and the service using one of the personal data associated with the party and at least one arbitrary pricing policy; and
anonymously purchasing one of the product and the service from the supplier.

2. The computer-implemented method of claim 1, further comprising:
using the at least one intelligent agent to reduce the price of one of the product and the service based upon one of an amount of the product in inventory, a form of payment by the party, a quantity of the product that is to be purchased, a rate at which the product sells, and a location where the product is to be provided to the party.

3. The computer-implemented method of claim 1, further comprising:
registering the party with the supplier of one of the product and the service without the party's active involvement provided that the party has not previously registered with the supplier.

4. The computer-implemented method of claim 1, further comprising:
performing data mining operations related to the purchase of one of the product and the service.

5. The computer-implemented method of claim 1, further comprising:
customizing a secure link between the client and the server based upon at least one preference established by the party.

6. The computer-implemented method of claim 1, further comprising:
using a transaction device to authorize the at least one intelligent agent to purchase one of the product and the service.

7. The computer-implemented method of claim 1, further comprising:
comparing a price for one of a first product and a first service from a first supplier to a price for one of a second product and a second service from a second supplier.

8. An apparatus comprising:
a client coupled to a server, the client adapted to configure and to dispatch to the server at least one intelligent agent to perform a plurality of tasks at the server, the plurality of tasks comprise to:
(a) determine whether one of the product and the service satisfies preferences established by a party; and
(b) use personal data associated with the party to customize a price for one of the product and the service, the personal data selected from the group consisting of a historical purchase activity of the party, a potential future purchase activity of the party, and a group to which the party is a member;
means for dispatching the at least one intelligent agent from the client to the server;
means for using the at least one intelligent agent to customize the price for one of the product and the service based upon at least one of the personal data associated with the party and an arbitrary pricing policy; and
means for purchasing one of the product and the service by using the at least one intelligent agent without disclosing an identity of the party.

9. The apparatus of claim 8, further comprising:
means for reducing the price of one of the product and the service by using the at least one intelligent agent based upon one of an amount of the product in inventory, a form of payment by the party, a quantity of the product that is to be purchased, a rate at which the product sells, and a location where the product is to be shipped.

10. The apparatus of claim 8, further comprising:
means for registering the party with a supplier by using the at least one intelligent agent without the party's active involvement provided that the party has not previously registered with the supplier.

11. The apparatus of claim 8, further comprising:
means for performing data mining operations related to the purchase of one of the product and the service.

12. The apparatus of claim 8, further comprising:
means for customizing a secure link between the client and the server based upon at least one preference established by the party.

13. The apparatus of claim 8, further comprising:
means for using a transaction device to authorize the at least one intelligent agent to purchase one of the product and the service.

14. A commerce system comprising:
a computer system;
a transaction terminal, coupled to the computer system, configured to receive a transaction device that provides a device identifier to the computer system and authorizes dispatching of an intelligent agent from the computer system, wherein the intelligent agent is configured to customize a price of one of the product and the service obtained from a server based upon one of a historical purchasing activity related to the user, a potential future purchasing activity related to the user, and a pricing policy; and
a transaction privacy clearinghouse, configured to withhold a user's identity, coupled selectively to the computer system during an electronic transaction.

15. The commerce system of claim 14, wherein the intelligent agent is configured to register the user with a supplier without providing an identity of the user.

16. The commerce system of claim 14, further comprising:
a secure link configured to connect the computer system to the server based upon at least one preference established by the user.

17. The commerce system of claim 14, wherein the intelligent agent is configured to customize the price of one of the product and the service based upon one of an amount of the product in inventory, a form of payment by the party, a quantity of the product that is to be purchased, a rate at where the product sells, and a location where the product is to be shipped.

18. The commerce system of claim 14, further comprising:
means for comparing a price for one of a first product and a first service from a first supplier to a price for one of a second product and a second service from a second supplier.

19. A machine readable storage media containing executable program instructions which when executed cause a digital processing system to perform a method comprising:
configuring at least one intelligent agent to:
(a) determine whether one of the product and the service satisfies preferences established by a party;
(b) use personal data associated with the party to customize a price for one of the product and the service, the personal data selected from the group consisting of a historical purchase activity of the party, a potential future purchase activity of the party, and a group to which the party is a member;
dispatching the at least one intelligent agent from a client to a server;
using the at least one intelligent agent to customize the price for one of the product and the service using one of the personal data associated with the party and at least one arbitrary pricing policy; and
anonymously purchasing by the intelligent agent of one of the product and the service.

20. The machine readable storage media of claim 19, wherein the method further comprises:
using the intelligent agent to reduce the price of one of the product and the service, based upon one of an amount of the product in inventory, a form of payment by the party, a quantity of the product that is to be purchased, a rate at which the product sells, a location where the product is to be provided to the party.

21. The machine readable storage media of claim 19, wherein the method further comprises:
registering the party with the supplier without the party's active involvement provided that the party has not previously registered with the supplier.

22. The machine readable storage media of claim 19, wherein the method further comprises:
performing data mining operations related to the purchase of one of the product and the service.

23. The machine readable storage media of claim 19, wherein the method further comprises:
customizing a secure link between the client and the server based upon at least one preference established by the party.

24. The machine readable storage media of claim 19, wherein the method further comprises:
using a transaction device to authorize an intelligent agent to purchase one of the product and the service.
